(19) United States
(12) Patent Application Publication
(10) Pub. No.: US 2004/0218671 A1
(43) Pub. Date: Nov. 4, 2004

(54) Picture information conversion method and apparatus

(76) Inventors: Shinya Haraguchi, Kanagawa (JP); Takahashi Kuniaki, Kanagawa (JP); Suzuki Teruhiko, Chiba (JP); Kato Shinya, Tokyo (JP)

Correspondence Address: JAY H. MAIOLI, Cooper & Dunham LLP, 1185 Avenue of the Americas, New York, NY, 10036, US

(21) Appl. No.: 09/819,190

(22) Filed: Mar. 28, 2001

(30) Foreign Application Priority Data
Mar. 30, 2000 (JP) P2000-097941
Mar. 15, 2000 (JP) P2000-072327

(51) Int. Cl. H04N 7/12

(52) U.S. Cl. 375/240.12

(57) ABSTRACT

A system for converting the MPEG2 compressed picture information into the MPEG4 compressed picture information, the processing volume and the capacity of the video memory needs to be diminished. To this end, the system includes a MPEG2 picture information decoding unit 19 for decoding the interlaced picture using only low 4×4 DCT coefficients of 8×8 DCT coefficients of a macroblock making up the MPEG2 compressed picture information by interlaced scanning, a scanning conversion unit 20 for selecting one of the first and second fields of the interlaced picture decoded by the MPEG2 picture information decoding unit 19 for generating a progressive-scanned picture, a decimating unit 21 for decimating the picture generated by the scanning conversion unit 20 and an encoding unit 22 for encoding the picture decimated by the decimating unit 21 to the MPEG4 compressed picture information.

### BACKGROUND OF THE INVENTION

1. Field of the Invention

This invention relates to a method and apparatus for converting the picture information. More particularly, it relates to a method and apparatus for picture information conversion used in receiving the compressed MPEG picture information (bitstream) obtained on orthogonal transform, such as discrete cosine transform, and motion compensation, over satellite broadcast, cable TV or a network medium, such as Internet, and also in processing the compressed MPEG picture information on a recording medium, such as an optical or magnetic disc.

2. Description of Related Art

Recently, a picture information compression system for compressing the picture information by orthogonal transform, such as MPEG, or motion compensation, by taking advantage of redundancy peculiar to the picture information, with a view to enabling the picture information to be handled as digital signals and to transmission and storage of the picture information with improved efficiency. Such an apparatus designed to cope with such picture information compression system is finding widespread use in both information distribution as is done in a broadcasting station and in information reception and viewing in household.

In particular, the MPEG2 (ISO/IEC 13818-2) is a standard defined as being a universal picture encoding system and which encompasses both the interlaced and progressive-scanned pictures and also both the standard resolution picture and the high-definition picture. The MPEG2 is expected to be used in future, as at present, for a wide range of applications including those for professional use and for consumers.

The use of the MPEG2 compression system renders it possible to realize a high compression rate and an optimum picture quality. To this end, it is necessary to allocate a bitrate of 4 to 8 Mbps and 18 to 22 Mbps for an interlaced picture having a standard resolution of 720×480 pixels and for a progressive-scanned picture having a high resolution of 1920×1088 pixels.

In digital broadcast, estimated to be in wide spread use in near future, the picture information is transmitted by this compression system. It is noted that, since this standard provides for a picture of standard resolution and a picture of high resolution, it is desirable for a receiver to have the function of decoding both the standard resolution picturte and the high resolution picture.

Meanwhile, the MPEG2, designed to cope with high picture quality encoding for use mainly in broadcasting, is not up to the encoding system for a bitrate a lower than that provided in MPEG1, that is the encoding system of high code rate. With coming into widespread use of portable terminals, such need of the encoding system is felt to be increasing in near future. The MPEG4 encoding system has been standardized in order to cope with such need. As for the picture encoding system, the written standard was recognized in December 1998 as an international standard under ISO/IEC 14496-2.

There is also a need for converting the MPEG2 compressed picture information (bitstream), once encoded for digital broadcasting, to the MPEG4 compressed picture information (bitstream) of a lower bitrate more suited to processing on a portable terminal.

As a picture information converting apparatus (transcoder) for achieving such objective, an apparatus shown in FIG. 1 is proposed in “Field-to-Frame Transcoding with Spatial and Temporal Downsampling” (Susie J. Wee, John G. Apostolopoulos, and Nick Feamster, ICIP′ 99).

This picture information conversion apparatus includes a picture type decision unit 12 for discriminating whether an encoded picture as the input interlaced MPEG2 compressed picture information is an intra-frame coded picture (I-picture), an inter-frame forward prediction-coded picture (P-picture) or an inter-frame bi-directionally predictive-coded picture (B-picture), and for allowing the I- and P-pictures to pass therethrough but discarding the P-picture. The picture information conversion apparatus also includes an MPEG2 picture information decoding unit 13 for decoding the MPEG2 compressed picture information from the picture type decision unit 12 comprised of the I- and P-pictures.

This picture information conversion apparatus also includes a decimating unit 14 for decimating pixels of an output picture from the MPEG2 picture information decoding unit 13 for reducing the resolution, and a MPEG4 picture information encoding unit 15 for encoding an output picture of the decimating unit 14 to an MPEG4 intra-frame encoded picture (I-VOP) of MPEG4 or to an inter-frame forward prediction coded picture (P-VOP).

The picture information conversion apparatus also includes a motion vector synthesis unit 16 for synthesizing the motion vector based on the motion vector of the MPEG2 compressed picture information output from a MPEG unit 13, and a motion vector detection unit 17 for detecting a motion vector based on a motion vector output from the motion vector synthesis unit 16 and on a picture output from the motion vector synthesis unit 16.

The input data of respective frames, in the interlaced MPEG2 picture compression information (bitstream), are checked in the picture type decision unit 12 as to whether the data belongs to the I/P picture or to the B picture, such that only the former picture, that is the I/P picture, is output to the next following MPEG2 picture information decoding unit (I/P picture) 13. Although the processing in the MPEG2 picture information decoding unit (I/P picture) 13 is similar to that of the routine MPEG2 picture information decoding apparatus, it is sufficient if the MPEG2 picture information decoding unit (I/P picture) 13 has the function of decoding only the I/P picture, since the data pertinent to the B-picture is discarded in the picture type decision unit 12.

The pixel value, as an output of the MPEG2 picture information decoding unit (I/P picture) 13, is fed to the decimating unit 14 where the pixels are decimated by ½ in the horizontal direction, whereas, in the vertical direction, only data of the first field or the second field are left, with the other data being discarded to generate a progressive-scanned picture having the size equal to one-fourth the size of the input picture information.

The progressive-scanned picture, generated by the decimating unit 14, is encoded by the MPEG4 picture information encoding unit 15 and output as the MPEG4 picture compression information (bitstream). The motion vector information in the input MPEG2 picture compression information (bitstream) is mapped by the motion vector synthesis unit 16 to the motion vector for the as-decimated picturte information. In the motion vector detection unit 17, the motion vector is detected to high precision based on the motion vector value synthesized by the motion vector synthesis unit 16.

If the input MPEG2 picture compression information (bitstream) is pursuant to the NTSC standard (720×480 pixels, interlaced scanning), the picture information conversion apparatus shown in FIG. 1 outputs the MPEG4 picture compression information (bitstream) of an SIF picture frame size (352×240 pixels, progressive-scanning) which is a picture frame size of an approximately ½ by ½ of the NTSC standard size. However, in a portable information terminal, as one of the MPEG4 target applications, there may be occasions where the resolution of a monitor is not sufficient to display the SIF size picture. There may also be occasions where the optimum picture quality cannot be obtained with the SIF size under the capacity of the storage medium or under the bitrate as set by the bandwidth of the transmission channel. In such case, it becomes necessary to convert the picture frame to a QSIF (176×112 pixels, progressive-scanning) which is a picture frame approximately ¼×¼ of the input MPEG2 picture compression information (bitstream). Moreover, since the information pertinent to high range components of the picture, discarded in a post-stage, is also processed in the MPEG2 picture information decoding unit (I/P picture) 13, both the processing volume and the memory capacity required for decoding may be said to be redundant.

### SUMMARY OF THE INVENTION

It is therefore an object of the present invention to provide a method and apparatus for converting the input interlaced MPEG2 compressed picture information to QSIF having a picture frame approximately ¼ by ¼ in size to reduce the processing volume required for decoding and the memory capacity.

In one aspect, the present invention provides a picture information conversion apparatus for converting the resolution of the compressed picture information obtained on discrete cosine transforming a picture in terms of a macroblock made up of eight coefficients for both the horizontal and vertical directions, as a unit, in which the apparatus includes decoding means for decoding an interlaced picture using only four coefficients for both the horizontal and vertical directions of the macroblock making up the input compressed picture information obtained on encoding the interlaced picture, scanning conversion means for selecting a first field or a second field of the interlaced picture decoded by the decoding means for generating a progressive-scanned picture, decimating means for decimating the picture generated by the scanning conversion means in the horizontal direction and encoding means for encoding a picture decimated by the decimating means to the output picture information lower in resolution than the input picture.

In another aspect, the present invention provides a picture information conversion method for converting the resolution of the compressed picture information obtained on discrete cosine transforming a picture in terms of a macroblock made up of eight coefficients for both the horizontal and vertical directions, as a unit, in which the method includes a decoding step for decoding an interlaced picture using only four coefficients for both the horizontal and vertical directions of the macroblock making up the input compressed picture information obtained on encoding the interlaced picture, a scanning conversion step for selecting a first field or a second field of the interlaced picture decoded by the decoding step for generating a progressive-scanned picture, a decimating step for decimating the picture generated by the scanning conversion step in the horizontal direction and an encoding step for encoding a picture decimated by the decimating step to the output picture information lower in resolution than the input picture.

According to the method and apparatus of the present invention, an interlaced MPEG2 picture compression information (bitstream) as an input is converted into the output progressive-scanned MPEG4 picture compression information (bitstream), having the resolution of ¼×¼ of the input bitstream, despite a circuit configuration having a smaller processing volume and a smaller video memory capacity.

### BRIEF DESCRIPTION OF THE DRAWINGS

FIG. 1 shows a structure of a conventional technique in which the MPEG2 compressed picture information (bitstream) is input and the MPEG4 compressed picture information (bitstream) is output.

FIG. 2 shows a structure of a picture information transforming apparatus embodying the present invention.

FIG. 3 is a block diagram showing a structure of an apparatus for performing the decoding using only the order-four low range information of the order-eight discrete cosine transform coefficients in both the horizontal and vertical directions in a picture information decoding apparatus embodying the present invention (4×4 downdecoder).

FIG. 4 shows the operating principle of a variable length decoder 3 in case of zig-zag scanning of an input MPEG2 compressed picture information (bitstream).

FIG. 5 shows the operating principle of a variable length decoder 3 in case of alternate scanning of an input MPEG2 compressed picture information (bitstream).

FIG. 6 shows the phase of pixels in a video memory 10.

FIG. 7 shows the operational principle in a decimating inverse cosine transform unit (field separation) 6.

FIG. 8 shows a technique of realizing the processing in the decimating inverse cosine transform unit (field separation) 6 using a fast algorithm.

FIG. 9 shows a technique of realizing the processing in the decimating inverse cosine transform unit (field separation) 6 using the fast algorithm.

FIG. 10 shows the operating principle in a motion compensation unit (field prediction) 8.

FIG. 11 shows the operating principle in a motion compensation unit (frame prediction) 9.

FIG. 12 shows a holding processing/mirroring processing in the motion compensation unit (field prediction) 8 and in the motion compensation unit (frame prediction) 9.

FIG. 13 shows an exemplary technique of reducing the processing volume in case a macro-block of the input compressed picture information (bitstream) is of the frame DCT mode.

FIG. 14 shows an operating principle in a scanning transforming unit 20.

FIG. 15 shows the operating principle on a decimating unit 21.

### DESCRIPTION OF THE PREFERRED EMBODIMENTS

Referring to the drawings, preferred embodiments of the present invention will be explained in detail.

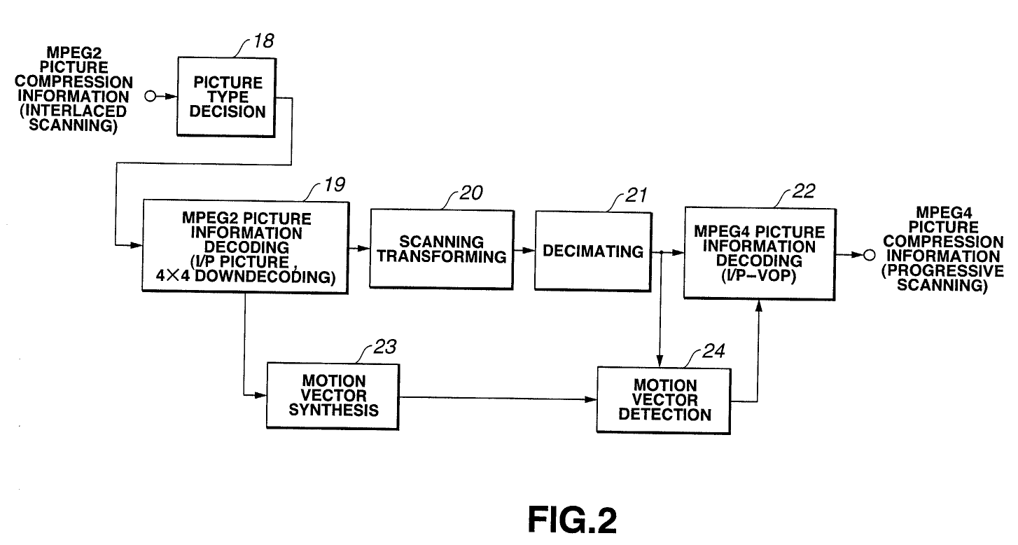

First, a picture information transforming apparatus embodying the present invention is explained with reference to FIG. 2.

This picture information transforming apparatus includes a picture type decision unit 18, for discriminating the type of the encoded picture constituting the input MPEG2 compressed picture information (bitstream), and a MPEG2 picture information decoding unit 19 for decoding the MPEG2 compressed picture information (bitstream) sent from the picture type decision unit 18.

The picture type decision unit 18 is fed with the MPEG2 compressed picture information (bitstream) obtained on interlaced scanning. This MPEG2 compressed picture information (bitstream) is made up of the intra-frame coded picture (I-picture), a forward inter-frame predictive-coded picture, obtained on predictive coding by having reference to another picture in the forward direction (P-picture), and a bi-directionally inter-frame predictive-coded picture, obtained on predictive coding by having reference to other pictures in the forward and backward directions (B-picture).

In the MPEG2 compressed picture information (bitstream), the picture type decision unit 18 discards the B-picture, leaving only the I- and P-pictures.

The MPEG2 picture information decoding unit 19 is a 4×4 downdecoder for partially decoding a macro-block using only four of eight horizontal and vertical discrete cosine transform (DCT) coefficients in the horizontal and vertical directions of a macroblock making up a picture of the MPEG2 compressed picture information (bitstream). The four coefficients in the horizontal and vertical directions and the eight coefficients in the horizontal and vertical directions are referred to below as 4×4 and 8×8, respectively.

That is, the MPEG2 picture information decoding unit 19 is fed with the MPEG2 compressed picture information (bitstream), made up of I- or P-pictures, referred to below as I/P pictures, from the picture type decision unit 18, and decodes an interlaced picture from the I/P pictures.

The picture information transforming apparatus also includes a scanning transforming unit 20 for transforming an interlaced picture output from the picture information decoding unit 19 into a progressive picture, a decimating unit 21 for decimating an output picture of the scanning transforming unit 20 and a MPEG4 picture information encoding unit 22 for encoding the picture thinned out by the decimating unit 21 into the MPEG4 compressed picture information (bitstream) using the motion vector sent from a motion vector detection unit 24.

The scanning transforming unit 20 leaves one of the first and second fields of the interlaced picture output by the MPEG2 picture information decoding unit 19 to discard the remaining field. The scanning transforming unit 20 generates a progressive picture from the remaining filed to transform the progressive picture so generated to a progressive picture with a size of ½×¼ of the interlaced input picture constituting the input MPEG2 compressed picture information (bitstream).

The decimating unit 21 performs ½-tupled downsampling in the horizontal direction on a picture converted by the scanning transforming unit 20 to a size ½×¼ of the input picture. This permits the decimating unit 21 to generate a picture with a size of ¼×¼ of the input picture size.

The MPEG4 picture information encoding unit 22 MPEG4-encodes the picture, with a size of ¼×¼ of the input picture size, output from the decimating unit 21, to output the encoded picture as the MPEG4 compressed picture information (bitstream).

This MPEG4 compressed picture information (bitstream) is constituted by a video object (VO). A video object plane (VOP) as a picture forming the VO is made up of an I-VOP, as an intra-frame encoded VOP, a P-VOP, as a forward predictive-coded VOP, a bi-directionally predictive-coded VOP and a splite encoded VOP.

The MPEG4 picture information encoding unit 22 MPEG4-encodes the output picture of the decimating unit 21 into the I-VOP and/or the P-VOP (I/P-VOP) to output the encoded picture as the MPEG4 compressed picture information (bitstream).

The picture information converting apparatus also includes a motion vector synthesis circuit 23, for synthesizing the motion vector detected by the MPEG2 picture information decoding unit 19, and a motion vector detection unit 24 for detecting the motion vector based on an output of the motion vector synthesis unit 23 and a picture from the decimating unit 21.

The motion vector synthesis unit 23 maps the scanning-transformed picture data, using a motion vector value, based on the motion vector value in the MPEG2 compressed picture information (bitstream) as detected by the MPEG2 picture information decoding unit 19.

Based on the motion vector value, output from the motion vector synthesis unit 23, the motion vector detection unit 24 detects the motion vector to high precision.

The operation of the present embodiment of the picture information converting apparatus is hereinafter explained.

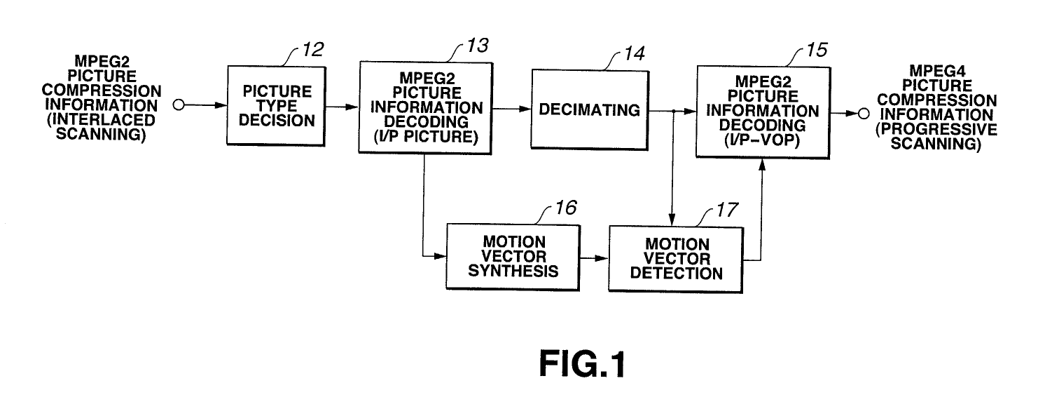

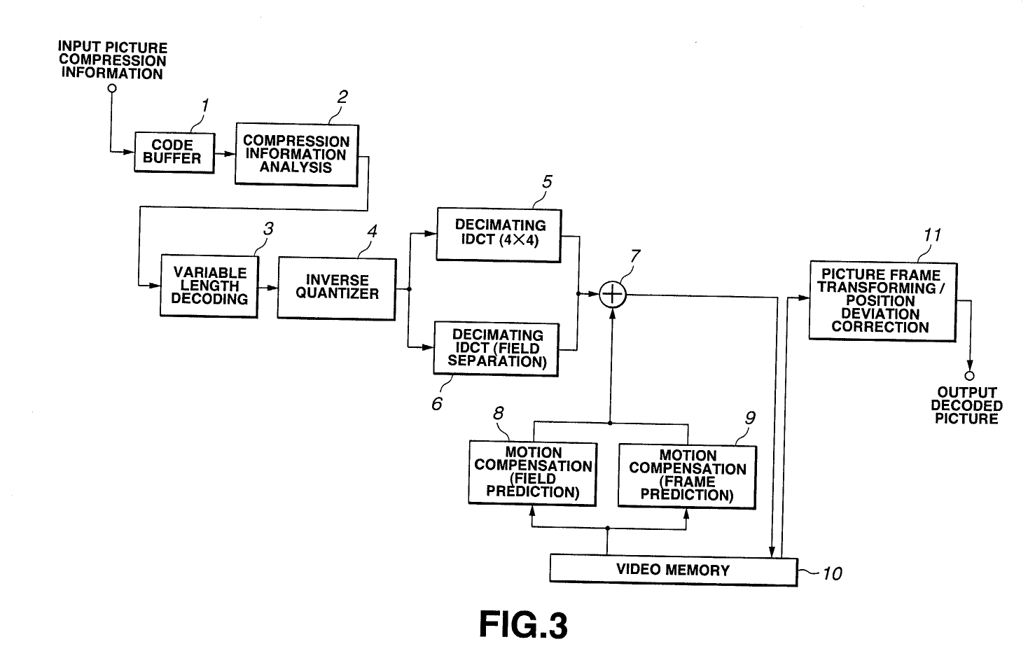

The input interlaced MPEG2 compressed picture information (bitstream) is first input to the picture type decision unit 18 which then outputs the information pertinent to the I/P picture as an input to the MPEG2 picture information decoding unit (I/P picture 4×4 downdecoder) 19. The information pertinent to the B-picture is discarded. The frame rate conversion proceeds in this fashion. Although the MPEG2 picture information decoding unit (I/P picture 4×4 downdecoder) 19 is equivalent to the corresponding component, shown in FIG. 3, it suffices if the MPEG2 picture information decoding unit (I/P picture 4×4 downdecoder) 19 decodes only the I/P picture, since the information concerning the B-picture has already been discarded in the picture type decision unit 17. Since the decoding is performed using only the low-range order-four information for both the horizontal and vertical directions, it is sufficient if the capacity of the video memory required in the MPEG2 picture information decoding unit (I/P picture 4×4 downdecoder) 19 is one-fourth of the capacity of a MPEG2 picture information decoding unit (I/P picture) 13 in FIG. 1. The processing volume required for IDCT equal to one-fourth and to one-half suffices for the field DCT mode and for the frame DCT mode, respectively. For the frame DCT mode, part of the DCT coefficients of 4×8 coefficients may be replaced by 0, as shown in FIG. 13, thereby decreasing the processing volume without substantially deteriorating the picture quality. In the drawing, a symbol a denotes a pixel value to be replaced by 0.

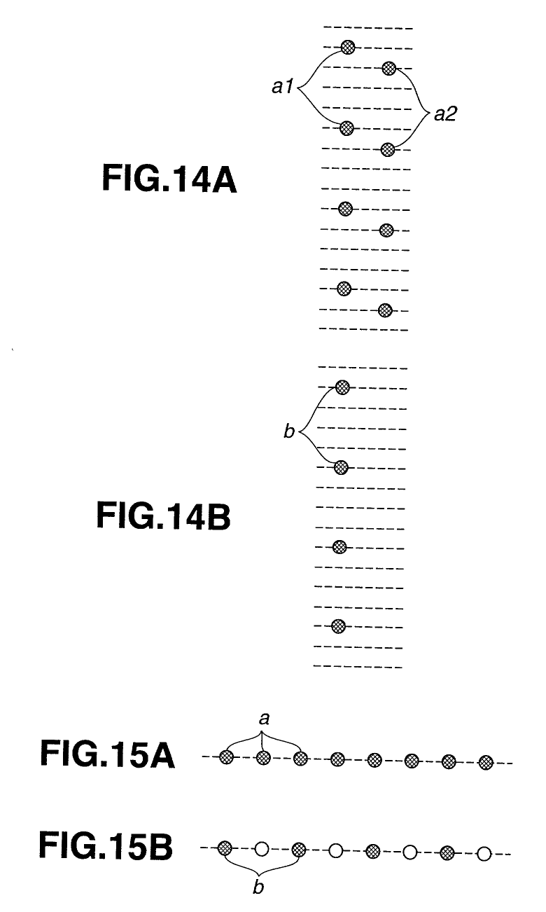

The input pixel data of the compressed picture information (bitstream) having a size of ½×½ is output as it is converted by the scanning converting unit 20 into progressive scanned pixel data of a size of ½×¼ of the input compressed picture information. The operating principle is shown in FIG. 14. Thus, in FIG. 14A, in which, of the pixel a1 of the first field and the pixel a2 of the second field, the pixel of the second field a2 is discarded to produce the pixel b shown in FIG. 14B.

The progressive scanned pixel data, sized ½×¼, of the input compressed picture information (bitstream) output from the scanning converting unit 20 is input to the decimating unit 21 where the data is downsampled by ½ in the horizontal direction for conversion to progressive-scanned pixel data having a size of ¼×¼ of the input compressed picture information (bitstream). The ½ downsampling may be executed by simple decimation or with the aid of a low-pass filter having several taps. The operating principle is shown in FIG. 15. Thus, in FIG. 15A, the pixel a is down-sampled by ½ in the horizontal direction to give a pixel b shown in FIG. 15B. The processing sequence in the scanning converting unit 20 may be reversed from that in the decimating unit 21. The progressive-scanned pixel data. sized ¼ by ¼, of the compressed picture information (bitstream), output from the decimating unit 21, is encoded by the MPEG4 picture information encoding unit (I/P-VOP) 22.

Meanwhile, in the MPEG4 picture information encoding unit (I/P-VOP) 22, the number of pixels of the luminance component in both the horizontal and vertical directions needs to be multiples of 16 in order to effect block-based processing. If the input compressed picture information (bitstream) is of the 420 format, the number of pixels of the chroma components need only be multiples of 8 in both the horizontal and vertical directions. If the input compressed picture information (bitstream) is of the 422 format, the numbers of pixels of the chroma components equal to multiples of 8 suffice for the horizontal direction. However, it needs to be multiples of 16 for the vertical direction. For the 444 format, the numbers of pixels of the chroma components need to be multiples of 16 in both the horizontal and vertical directions.

To this end, the numbers of pixels in the horizontal and vertical directions are adjusted by the scanning converting unit 20 and by the decimating unit 21, respectively. That is, if the luminance components of the input compressed picture information (bitstream) are 720×480 pixels, the size of the picture following extraction only of the first or the second field in the scanning converting unit is 360×120. Since 160 is not a multiple of 16, lower 8 lines of the pixel data, for example, are discarded to give 360×112 pixels, in which 112 is a multiple of 16. If the picture is processed in the decimating unit 21, the result is 180×112 pixels. Since 180 is not a multiple of 16, 8 right lines of the pixel data, for example, are discarded to give 176×112 pixels, in which 176 is a multiple of 16.

The motion vector information in the input MPEG2 compressed picture information (bitstream), as detected by the MPEG2 picture information decoding unit (I/P picture 4×4 downdecoder) 19, is input to the motion vector synthesis unit 23 so as to be mapped to motion vector values in the progressive scanned picture following scanning conversion. In the motion vector detection unit 24, high-precision motion detection is performed based on the motion vector value in a progressive scanned picture, output following scanning conversion from the motion vector synthesis unit 23.

The 4×4 downdecoder, adapted for decoding low-range 4×4 coefficients in the 8×8 macroblock, is explained with reference to FIG. 3.

This 4×4 downdecoder includes a code buffer 1 for transiently storing the input compressed picture information, a compressed picture analysis unit 2 for analyzing the input compressed picture information, a variable length decoding unit 3 for variable-length decoding the input compressed picture information and an inverse quantizer 4 for inverse-quantizing an output of the variable length decoding unit 3.

The 4×4 downdecoder includes a decimating IDCT unit (4×4) 5 for IDCTing only low 4×4 coefficients of the 8×8 coefficients, output from the inverse quantizer 4, and a decimating IDCT (field separation unit) 5 for separating first and second fields making up an interlaced picture.

The 4×4 downdecoder also includes a motion compensation unit (field prediction) 8 for motion-predicting a picture supplied from a video memory 10 on the field basis to effect motion compensation, a motion compensation unit (frame prediction) 9 for motion-predicting a picture supplied from the video memory 10 on the frame basis to effect motion compensation, an adder 7 for summing outputs of these units and outputs of the decimating IDCT unit (4×4) 5 and a decimating IDCT unit (field separation) 6 together, the video memory 10 for storing an output of the adder 7, and a picture frame/dephasing correction unit 11 for picture-frame-correcting and dephasing-correcting a picture stored in the video memory 10 to output the corrected picture.

In this 4×4 downdecoder, the code buffer 1, compressed picture analysis unit 2, variable length decoding unit 3 and the inverse quantizer 4 operate under an operating principle of a customary picture decoding device.

Alternatively, the variable length decoding unit 3 may be designed so that, depending on whether the DCT mode of the macro-block is the field DCT mode or the frame DCT mode, the variable length decoding unit 3 decodes only DCT coefficients required in the post-stage side decimating IDCT unit (4×4) 5 or in the decimating IDCT unit (field separation) 6, with the subsequent operation not being performed until the time of EOB detection.

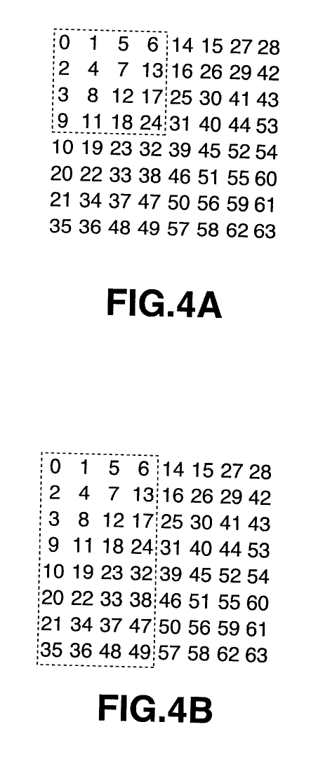

The operating principle in the variable length decoding unit 3 in case the input MPEG2 compressed picture information (bitstream) is zig-zag scanned is explained with reference to FIG. 4, in which the numbers entered indicate the sequence of reading the DCT coefficients.

In the case of the frame DCT mode, the decimating IDCT unit (4×4) 5 variable-length-decodes only DCT coefficients of the low-range 4×4 coefficients surrounded by a broken line in an 8×8 macro-block, as shown in FIG. 4A, whereas, in the case of the field DCT mode, the decimating IDCT unit (field separation) 6 variable-length-decodes only DCT coefficients of the low-range 4×8 coefficients surrounded by a broken line in the 8×8 macro-block, as shown in FIG. 4B.

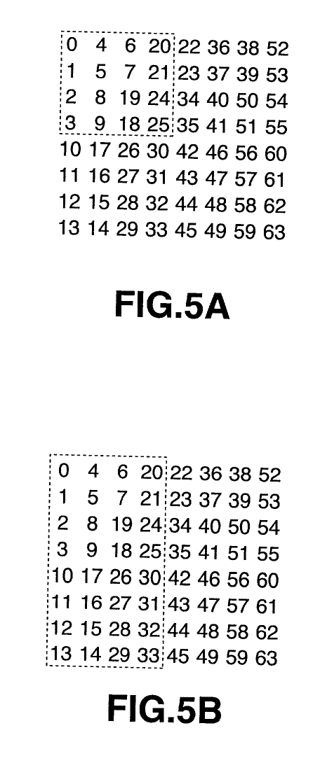

The operating principle in the variable length decoding unit 3 in case the input MPEG2 compressed picture information (bitstream) is alternately scanned is explained with reference to FIG. 5.

In the case of the frame DCT mode, the decimating IDCT unit (4×4) 5 variable-length-decodes only DCT coefficients of the low-range 4×4 coefficients surrounded by a broken line in an 8×8 macro-block, as shown in FIG. 5A, whereas, in the case of the field DCT mode, the decimating IDCT unit (field separation) 6 variable-length-decodes only DCT coefficients of the low-range 4×8 coefficients surrounded by a broken line in the 8×8 macro-block, as shown in FIG. 5B.

The DCT coefficients, inverse-quantized by the inverse quantizer 4, are IDCTed in the decimating IDCT unit (4×4) 5 and in the decimating IDCT unit (field separation) 6, respectively, if the DCT mode of the macro-block is the frame DCT mode or the field DCT mode, respectively.

An output of the decimating IDCT unit (4×4) 5 or the decimating IDCT unit (field separation) 6 is directly stored in the video memory 10 if the macroblock in question is an intra-macroblock.

An output of the decimating IDCT unit (4×4) 5 or the decimating IDCT unit (field-separation) 6 is synthesized by the adder 7 with a predicted picture interpolated to ¼ pixel precision in each of the horizontal and vertical directions, based on reference data in the video memory 10, by the motion compensation unit (field prediction) 8 or by the motion compensation unit (frame prediction) 9 if the motion compensation mode is the field prediction mode or if the motion compensation mode is the frame prediction mode, respectively. The resulting synthesized data is output to the video memory 10.

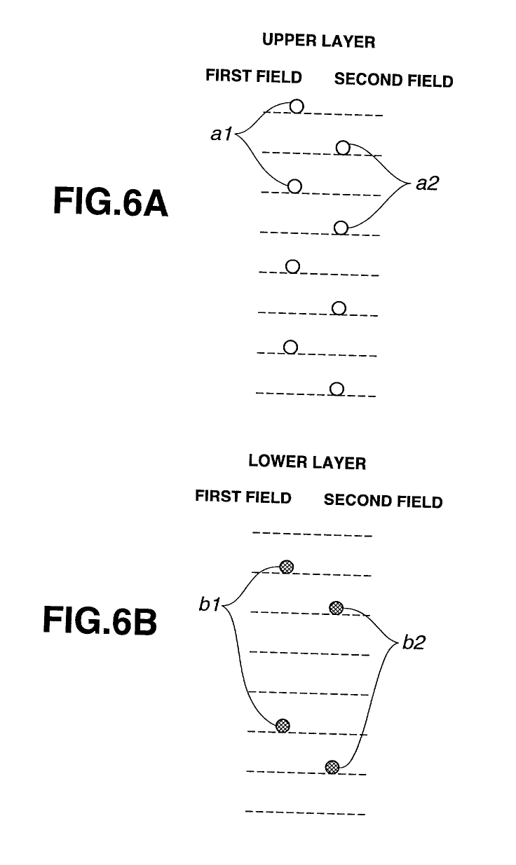

In association with pixels of the upper layer, the pixel values stored in the video memory 10 comprehend dephasing between the first and second fields, as may be seen from the upper layer shown in FIG. 6A and the lower layer shown in FIG. 6B.

In the upper layer of FIG. 6A, there are shown pixels a1 of the first field and pixels a2 of the second field. In the lower layer of FIG. 6B, there are shown pixels b1 of the first field and pixels b2 of the second field. The pixel values of the lower layer, shown in FIG. 6B, are obtained by subtracting the number of the pixels of the upper layer by decimating IDCT. These pixel values, however, comprehend inter-field dephasing.

The pixel values, stored in the video memory 10, are converted to a picture frame size, suited to a display device in use, by the picture frame/dephasing correction unit 11, while being corrected for inter-field dephasing.

The decimating IDCT unit (4×4) 5 take out low-range 4 by 4 coefficients of the 8 by 8 coefficients of the DCT coefficients to apply order-four IDCT to the so-taken-out 4 by 4 coefficients.

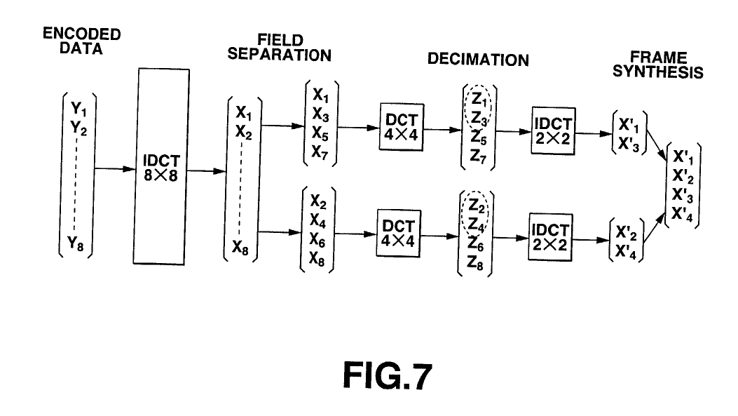

FIG. 7 shows the processing of the decimating IDCT unit (field separation) 6. That is, 8×8 IDCT is applied to DCT coefficients y₁ to y₈, as encoded data in the input compressed picture information (bitstream) to produce decoded data x₁ to x₈. These decoded data x₁ to x₈ then are separated into first-field data x₁, x₃, x₅, x₇, and second field data x₂, x₄, x₆, x₈.

The respective separated data strings are processed with 4×4 IDCT to produce DCT coefficients z₁, z₃, z₅, z₇ for the first field and DCT coefficients z₂, z₄, z₆, z₈ for the second field.

The DCT coefficients for the first and second fields, thus obtained, are decimated to leave two low-range coefficients. That is, of the DCT coefficients for the first field, z₅, z₇ are discarded, whereas, of the DCT coefficients for the second field, z₆, z₈, are discarded. This leaves the DCT coefficients z₁, z₃ for the first field, while leaving DCT coefficients z₂, z₄ for the second field.

The low-range DCT coefficients z₁, z₃ for the first field and the low-range DCT coefficients z₂, z₄, thus decimated, are processed with 2×2 IDCT to give decimated pixel values x₁′, x′₃ for the first field and decimated pixel values x′₂, x′₄ for the second field.

These values are again synthesized into a frame to give pixel values x′₁ to x′₄, as output values.

Meanwhile, in actual processing, the pixel values x₁′ to x′₄ are directly obtained by applying a matrix equivalent to these series of processing operations to the DCT coefficients y₁ to y₈. This matrix [FS′], obtained by expansion calculations employing the addition theorem, is given by the following equation (1):

$$[ {FS}^{′} ] = \frac{1}{\sqrt{2}} [ \begin{matrix}A & B & D & - E & F & G & H & I \\ A & - C & - D & E & - F & - G & - H & - J \\ A & C & - D & - E & - F & G & - H & J \\ A & - B & D & E & F & - G & H & - I\end{matrix} ] . \qquad ( 1 )$$

In the above equation (1), A to J are given as follows:

$$\begin{matrix}A = \frac{1}{\sqrt{2}} \\ B = \frac{cos \frac{π}{16} + cos \frac{3 π}{16} + 3 cos \frac{5 π}{16} - cos \frac{7 π}{16}}{4} \\ C = \frac{cos \frac{π}{16} - 3 cos \frac{3 π}{16} - cos \frac{5 π}{16} - cos \frac{7 π}{16}}{4} \\ D = \frac{1}{4} \\ E = \frac{cos \frac{π}{16} - cos \frac{3 π}{16} - cos \frac{5 π}{16} - cos \frac{7 π}{16}}{4} \\ F = \frac{cos \frac{π}{8} cos \frac{3 π}{8}}{4} \\ G = \frac{cos \frac{π}{16} - cos \frac{3 π}{16} + cos \frac{5 π}{16} + cos \frac{7 π}{16}}{4} \\ H = \frac{1}{4} + \frac{1}{2 \sqrt{2}} \\ I = \frac{cos \frac{π}{16} - cos \frac{3 π}{16} + 3 cos \frac{5 π}{16} + cos \frac{7 π}{16}}{4} \\ J = \frac{cos \frac{π}{16} + 3 cos \frac{3 π}{16} - cos \frac{5 π}{16} + cos \frac{7 π}{16}}{4}\end{matrix}$$

The 4×4 decimating IDCT and field separation decimating IDCT may be realized by fast algorithm. The following shows the technique which is based on Wang's algorithm (reference material: Zhong de Wang, “Fast Algorithm for the Discrete W Transform and for the Discrete Fourier Transform”, IEEE Tr. ASSP-32, No. 4, pp. 803-816, August 1984).

A matrix representing the decimating IDCT for 4×4 coefficients is decomposed, using the Wang's fast algorithm, as indicated by the following equation (2):

$${[ {C}_{4}^{II} ]}^{- 1} = [ \begin{matrix}1 & 0 & 0 & 1 \\ 0 & 1 & 1 & 0 \\ 0 & 1 & - 1 & 0 \\ 1 & 0 & 0 & - 1\end{matrix} ] [ \begin{matrix}{C}_{2}^{III} & \\ & \overline{{C}_{2}^{III}}\end{matrix} ] [ \begin{matrix}1 & 0 & 0 & 1 \\ 0 & 0 & 1 & 0 \\ 0 & 0 & 0 & 1 \\ 0 & 1 & 0 & 0\end{matrix} ] \qquad ( 2 )$$

where a matrix and elements as defined below are used:

processing may be resolved by the Wang algorithm as indicated by the following equation (17).

$$\begin{matrix}[ {C}_{2}^{III} ] = {[ {C}_{d}^{II} ]}^{T} = \frac{1}{\sqrt{2}} [ \begin{matrix}1 & 1 \\ 1 & - 1\end{matrix} ] \\ [ \overline{{C}_{2}^{III}} ] = [ \begin{matrix}- {C}_{\frac{1}{8}} & {C}_{\frac{9}{8}} \\ {C}_{\frac{9}{8}} & {C}_{\frac{1}{8}}\end{matrix} ] = [ \begin{matrix}1 & 0 & - 1 \\ 0 & 1 & 1\end{matrix} ] [ \begin{matrix}- {C}_{\frac{1}{8}} + {C}_{\frac{9}{8}} & 0 & 0 \\ 0 & {C}_{\frac{1}{8}} + {C}_{\frac{9}{8}} & 0 \\ 0 & 0 & {C}_{\frac{9}{8}}\end{matrix} ] [ \begin{matrix}1 & 0 \\ 0 & 1 \\ 1 & - 1\end{matrix} ]\end{matrix}$$

Cr=cos(rπ)

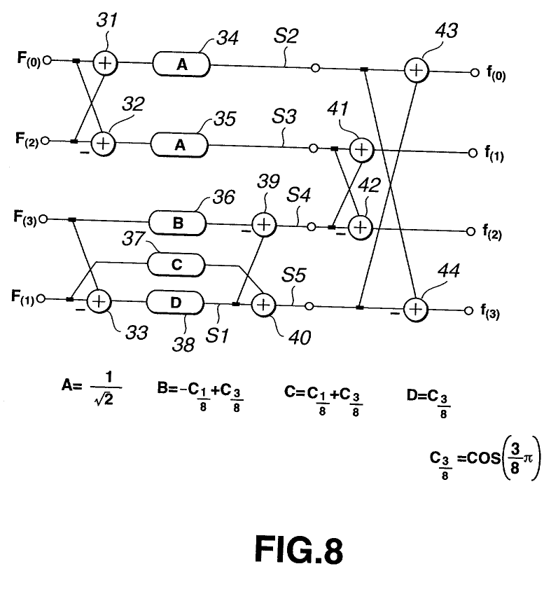

This configuration is shown in FIG. 8. The present apparatus can be constructed and nine adders.

In FIG. 8, a 0th output element f(0) is obtained by adding values s2 and s5 in an adder 43.

The value s2 is obtained on summing the 0th input element F(0) to the second input element F(2) in the adder 1 and on multiplying the resulting sum by A in a multiplier 34. The value s5 is obtained on multiplying the first input element F(1) with C by a multiplier 37 and summing the resulting product to a value s1 in the adder 40. The value s1 is a value obtained on subtracting the first input element F(1) from the third input element F(3) by the adder 33 and on multiplying the resulting difference by D in the multiplier 38.

The output element f(1) is obtained on summing the values s3 and s4 in the adder 41.

The value s3 is obtained on subtracting the second input element F(2) from the 0th input element F(0) by an adder 32 and on multiplying the resulting difference by A by a multiplier 35. The value s4 is obtained on subtracting the value s1 from a value obtained on multiplying the third input element F(3) by B in a multiplier 36 and on subtracting the value s1 from the resulting product in an adder 39.

The second output element f(2) is obtained on subtracting the value s3 from the value s4 in an adder 42.

The third output element f(3) is obtained on subtracting the value s5 from the value s2 in an adder 44.

In the drawings, the following values are used:

A=1/\sqrt{2}

B=-C_{1/8}+C_{3/8}

C=C_{1/8}+C_{3/8}

D=C_{3/8}

providing that the following number:

C_{3/8}=cos(3π/8)

is used in the above equations, hereinafter the same.

The matrix of the equation (1) representing the field separation type decimating IDCT may be resolved by the Wang fast algorithm as indicated by the following equation (3):

$$\begin{matrix}[ {FS}^{′} ] = \frac{1}{\sqrt{2}} [ \begin{matrix}1 & 0 & 0 & 0 \\ 0 & 0 & 0 & 1 \\ 0 & 1 & 0 & 0 \\ 0 & 0 & 1 & 0\end{matrix} ] [ \begin{matrix}1 & 0 & 1 & 0 \\ 0 & 1 & 0 & 1 \\ 1 & 0 & - 1 & 0 \\ 0 & 1 & 0 & - 1\end{matrix} ] [ \begin{matrix}[ {M}_{1} ] & \\ & [ {M}_{2} ]\end{matrix} ] \\ [ \begin{matrix}1 & 0 & 0 & 0 & 0 & 0 & 0 & 0 \\ 0 & 0 & 1 & 0 & 0 & 0 & 0 & 0 \\ 0 & 0 & 0 & 0 & 1 & 0 & 0 & 0 \\ 0 & 0 & 0 & 0 & 0 & 0 & 1 & 0 \\ 0 & 0 & 0 & 1 & 0 & 0 & 0 & 0 \\ 0 & 0 & 0 & 0 & 0 & 1 & 0 & 0 \\ 0 & 1 & 0 & 0 & 0 & 0 & 0 & 0 \\ 0 & 0 & 0 & 0 & 0 & 0 & 0 & 1\end{matrix} ]\end{matrix}$$

in the above equation (3), the minor matrix is defined as follows:

$$\begin{matrix}[ {M}_{1} ] = [ \begin{matrix}1 & 1 \\ - 1 & - 1\end{matrix} ] [ \begin{matrix}1 & 0 & 0 & 0 \\ 0 & 1 & 1 & 1\end{matrix} ] [ \begin{matrix}A & 0 & 0 & 0 \\ 0 & D & 0 & 0 \\ 0 & 0 & F & 0 \\ 0 & 0 & 0 & H\end{matrix} ] \\ [ {M}_{2} ] = [ \begin{matrix}1 & 1 & 0 \\ 1 & 0 & 1\end{matrix} ] [ \begin{matrix}- 1 & 1 & 0 & 0 & 0 & 0 \\ 0 & 0 & 1 & 0 & 1 & 0 \\ 0 & 0 & 0 & 1 & 0 & 1\end{matrix} ] [ \begin{matrix}E & 0 & 0 & 0 \\ 0 & G & 0 & 0 \\ 0 & 0 & B & 0 \\ 0 & 0 & C & 0 \\ 0 & 0 & 0 & I \\ 0 & 0 & 0 & J\end{matrix} ]\end{matrix}$$

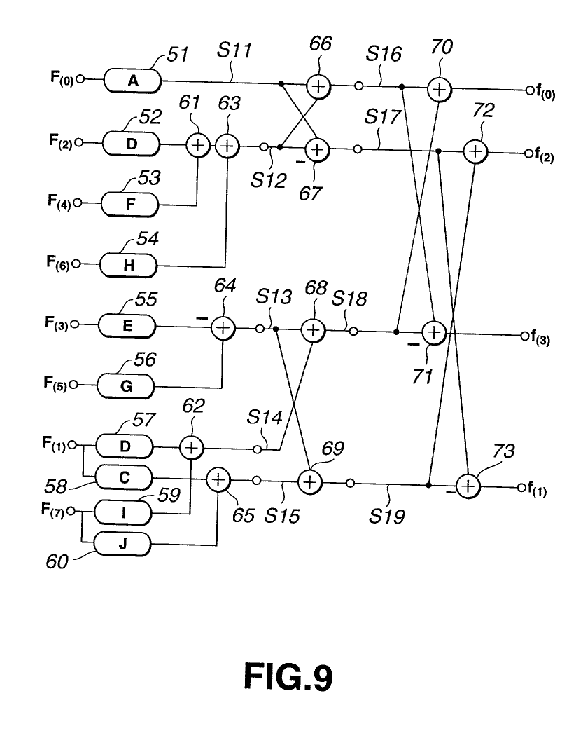

As for the elements A to J, what has been said in connection with the equation (1) holds. FIG. 9 shows this configuration. The present apparatus can be constructed in this manner using ten multipliers and thirteen adders 13.

That is, the 0th output element f(0) is the values s16 and s18 summed together by an adder 70.

A value s16 is values s11 and s12 summed together by the adder 66, whilst a value s11 is the 0th input element F(0) multiplied by A in a multiplier 51. The value s12 is obtained on summing by an adder 63 a sixth input element F(6) multiplied by H by a multiplier 54 to a sum by an adder 61 of the second input element F(2) multiplied by D in a multiplier 52 and the fourth input element F(4) multiplied by F by the multiplier 53.

The first output element f(1) is obtained on subtracting a value s19 from a value s17 in an adder 73.

Meanwhile, the value s17 is obtained on subtracting the value s12 from the value s11 in the adder 67. The value s19 is obtained on adding values s13 and s15 in an adder 69. The value s13 is obtained by subtracting by an adder 64 a fifth input element F(5) multiplied by G in a multiplier 56 from the third input element F(3) multiplied by E in the multiplier 55. The value s15 is the sum in an adder 65 of the first input element F(1) multiplied by C in a multiplier 58 and a seventh input element F(1) multiplied by J in a multiplier 60.

A second output element f(2) is obtained on summing the values s17 and s19 in an adder 72.

A third output element f(3) is obtained on subtracting a value s18 from a value s16 in an adder 71.

The value s18 is a sum of the values s13 and s14 in an adder 68. The value s14 is the sum in an adder 62 of the first input element F(1) multiplied by B in the multiplier 57 and a seventh input element F(7) multiplied by I in a multiplier 59.

The operations by the motion compensation unit (field prediction) 8 and the motion compensation unit (frame prediction) 9, respectively associated with the field motion compensation mode and the frame motion compensation mode, are hereinafter explained. Insofar as interpolation in the horizontal direction is concerned, pixels of approximately ½ precision are first produced, for both the field and frame motion compensation modes, by a double interpolation filter, such as a half-band filter, and pixels of approximately ¼ pixel precision are then produced by linear interpolation, based on the so-created pixels. In outputting pixel values of the same phase as the phase of the pixels taken out from the frame memory, a half-band filter may be used to eliminate the necessity of performing product/sum processing in meeting with the number of taps to enable fast processing operations. Moreover, if the half-band filter is used, the division accompanying the interpolation can be executed by bit-shifting operations, thus enabling faster processing. Alternatively, pixels required for motion compensation may be directly produced by four-tupled interpolation filtering.

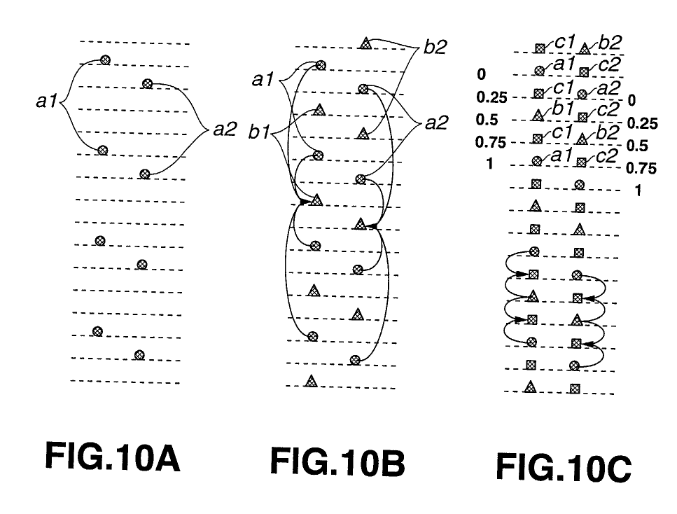

FIG. 10 is pertinent to interpolation in the vertical direction of the motion compensation unit (field prediction) 8 associated with the field motion compensation mode. First, responsive to values of the motion vector in the input compressed picture information (bitstream), pixel values containing inter-field dephasing are taken out from the video memory 10. In FIG. 10A, symbols a1 and a2, shown on the left and right sides, respectively, are associated with pixels of the first and second fields, respectively. It is noted that first field pixels are dephased with respect to second field pixels.

Using a double interpolation filter, such as a half-band filter, pixel values of approximately ½ pixel precision are produced in a field, using a double interpolation filter, such as a half-band filter, as shown in FIG. 10B. The pixels produced by double interpolation in the first and second fields, using the double interpolation filter, are represented by symbols b1 and b2, respectively.

Then, pixel values corresponding to approximately ¼ pixel precision are produced by intra-field linear interpolation, as shown in FIG. 10C. The pixels produced in the first and second fields by linear interpolation are represented by symbols c1 and c2, respectively. If pixel values of the same phase as the pixel taken out from the frame memory are output as a prediction picture, the use of the half-band filter eliminates the necessity of performing product/sum processing associated with the number of taps, thus assuring fast processing operations. Alternatively, a pixel value corresponding to the phase of FIG. 10C may be produced by four-tupled interpolation filtering based on the pixel value shown in FIG. 10A.

For example, if pixels of the first field are present at e.g., positions 0, 1, etc., pixels by double interpolation are produced at position e.g., of 0.5. The pixels by linear interpolation are also created at positions 0.25, 0.75, etc. The same applies for the second field. In the drawings, the first field position is deviated by 0.25 from the second field position.

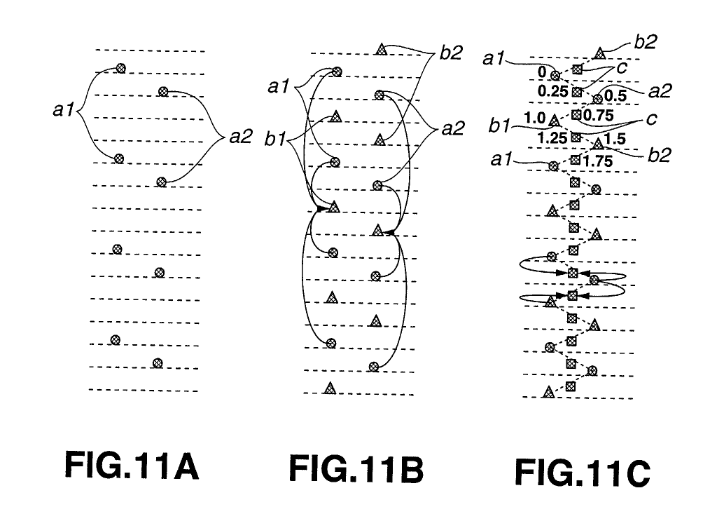

FIG. 11 is pertinent to interpolation in the vertical direction of the motion compensation unit (frame prediction) 9 associated with the field motion compensation mode. First, responsive to values of the motion vector in the input compressed picture information (bitstream), pixel values containing inter-field dephasing are taken out from the video memory 10. In FIG. 11A, symbols a1 and a2, shown on the left and right sides, respectively, are associated with pixels of the first and second fields, respectively. It is noted that first field pixels are dephased with respect to second field pixels.

Using a double interpolation filter, such as a half-band filter, pixel values of approximately ½ pixel precision are produced in a field, using a double interpolation filter, such as a half-band filter, as shown in FIG. 11B. The pixels produced by double interpolation in the first and second fields, using the double interpolation filter, are represented by symbols b1 and b2, respectively.

Then, inter-field linear interpolation is performed, as shown in FIG. 11C, to produce pixel values corresponding to approximately ¼ pixel precision. The pixels produced in the first and second fields by linear interpolation are represented by symbols c.

For example, if pixels of the first field are present e.g., at positions 0, 2, and those of the second field are present e.g., at positions 0.5, 2.5, pixels of the first field by double interpolation are produced e.g., at a position 1, whilst those of the second field by double interpolation are produced e.g., at a position 1.5. Moreover, pixels by linear interpolation are produced e.g., at positions 0.25, 0.75, 1.25 or 1.75.

By this interpolating processing, field inversion or field mixing, responsible for picture quality deterioration, may be prevented from occurring. Moreover, by using a half-band filter, fast processing operations are possible if pixel values of the pixels of the same phase as those taken out from the frame memory are output as a predicted picture, since then there is no necessity of executing product/sum processing in association with the number of taps.

In an actual processing, there are provided at the outset a set of coefficients, for both horizontal processing and vertical processing, whereby the two-stage interpolation performed by the double interpolation filter and linear interpolation may be carried out by one step such that it may appear as if the processing is one-stage processing. In addition, for both horizontal processing and vertical processing, only necessary pixel values are produced depending on the values of the motion vectors in the input compressed picture information (bitstream). It is also possible to provide filter coefficients corresponding to motion vector values in the horizontal and vertical directions at the outset so that interpolation in the horizontal and vertical directions will be carried out at a time.

In carrying out double interpolation filtering, there are occasions where reference must be had to an area outside a picture frame in the video memory 10, depending on motion vector values. In such case, symmetrical mirroring is made a required number of taps about a terminal point as center, by way of a processing termed mirroring processing, or a number of pixels equal to the number of pixel values of the terminal point are deemed to be present outside a picture frame, by way of a processing termed holding processing.

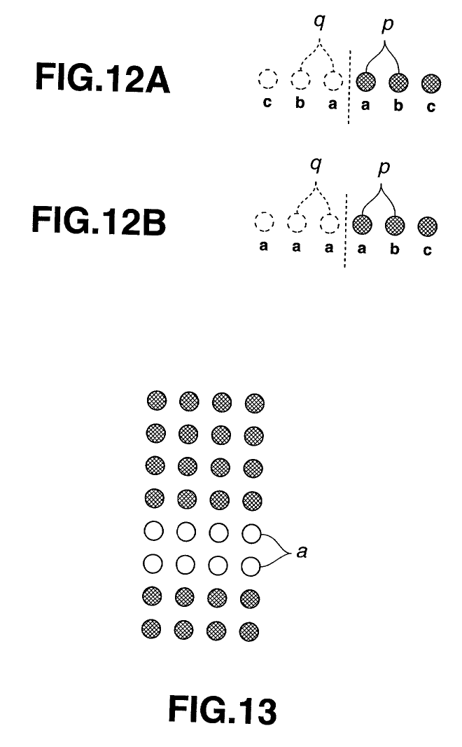

FIG. 12A shows the mirroring processing, where symbols p, q denote a pixel within the video memory 10 and a virtual pixel outside a picture frame required for interpolation, respectively. These pixels outside the picture frame are pixels in the picture frame mirrored symmetrically about an edge of the picture frame as center.

FIG. 12B shows the holding processing. The mirroring or holding processing on pixels outside a picture frame are performed on the field basis in both the motion compensation unit (field prediction) 8 and motion compensation unit (frame prediction) 9 in a direction perpendicular to the picture frame within the picture frame. Alternatively, a fixed value, such as 128, may be used for pixel values lying outside the picture frame for both the horizontal and vertical directions.

In the foregoing description, an input is the MPEG2 compressed picture information (bitstream) and an output is a MPEG4 compressed picture information (bitstream). The input or the output is, however, not limited thereto, but may, for example, be the compressed picture information (bitstream), such as MPEG-1 or H.263.

The present embodiment, described above, contemplates to provide for co-existence of the high resolution picture and the standard resolution picture and decimates the high resolution picture as the picture quality deterioration is suppressed to a minimum, thus allowing to construct an inexpensive receiver.

The co-existence of the high resolution picture and the standard resolution picture is felt to occur not only in transmission mediums, such as digital broadcast, but also in storage mediums, such as optical discs or flash memories.

What is claimed is:

1. A picture information conversion apparatus for converting the resolution of the compressed picture information obtained on discrete cosine converting a picture in terms of a macroblock made up of eight coefficients for both the horizontal and vertical directions, as a unit, said apparatus comprising:
decoding means for decoding an interlaced picture using only four coefficients for both the horizontal and vertical directions of the macroblock making up the input compressed picture information obtained on encoding the interlaced picture;
scanning conversion means for selecting a first field or a second field of the interlaced picture decoded by said decoding means for generating a progressive-scanned picture;
decimating means for decimating the picture generated by said scanning conversion means in the horizontal direction; and
encoding means for encoding a picture decimated by said decimating means to the output picture information lower in resolution than said input picture.

2. The picture information conversion apparatus according to claim 1 wherein said input compressed picture information is by the MPEG2 standard and wherein said output compressed picture information is by the MPEG2 4 standard.

3. The picture information conversion apparatus according to claim 1 wherein said decimating means performs ½ downsampling in the horizontal direction of said picture and wherein said output compressed picture information has the resolution of ¼ for both the horizontal and vertical directions with respect to said input compressed picture information.

4. The picture information conversion apparatus according to claim 4 wherein said input compressed picture information is made up of an intra-coded picture, encoded in a frame, a forward predictive-coded picture, obtained on inter-frame predictive coding by referencing another picture in the forward direction, and an inter-frame bi-directionally predictive-coded picture, obtained on inter-frame predictive coding by referencing other pictures in both the forward and backward directions, there being provided discriminating means for deciphering the type of the encoded picture constituting the input compressed picture information for allowing passage therethrough of the intra-coded picture and the forward predictive-coded picture but discarding the bi-directionally predictive-coded picture, said decoding means being fed with the compressed picture information through said discriminating means.

5. The picture information conversion apparatus according to claim 4 wherein said decoding means decodes only intra-coded and forward predictive-coded pictures.

6. The picture information conversion apparatus according to claim 1 wherein said input compressed picture information has been variable-length coded;
said decoding means including variable length decoding means for variable-length decoding the compressed picture information and IDCT means for inverse discrete cosine converting the compressed picture information variable-length decoded by said variable length decoding means, said variable length decoding means variable-length decoding only DCT coefficients necessary for IDCT in said IDCT means depending on whether a macroblock forming said input compressed picture information is the field mode or the frame mode.

7. The picture information conversion apparatus according to claim 6 wherein said IDCT means is associated with the field mode and applies IDCT to DCT coefficients of four horizontal and vertical low-range coefficients of eight horizontal and vertical DCT coefficients making up said macroblock.

8. The picture information conversion apparatus according to claim 6 wherein said IDCT executes processing operations using a pre-set fast algorithm.

9. The picture information conversion apparatus according to claim 6 wherein said IDCT means is associated with the frame mode and applies IDCT to DCT coefficients of four horizontal low-range coefficients of the eight horizontal and vertical DCT coefficients making up said macroblock, said IDCT means applying field separation IDCT to DCT coefficients of four vertical low-range coefficients of the eight horizontal and vertical DCT coefficients.

10. The picture information conversion apparatus according to claim 9 wherein said IDCT executes processing operations using a pre-set fast algorithm.

11. The picture information conversion apparatus according to claim 9 wherein said IDCT means executes IDCT on four horizontal and vertical DCT coefficients of four horizontal and eight vertical DCT coefficients and also using four horizontal low-range coefficients and two vertical DCT coefficients consecutive vertically to said four low-range horizontal and vertical low-range coefficients, with the remaining coefficients being set to 0.

12. The picture information conversion apparatus according to claim 1 wherein said input compressed picture information has been motion-compensated using a motion vector, said decoding means including motion compensation means for motion-compensating a picture using motion vector, said motion compensation means executing interpolation to ¼ pixel precision for both the horizontal and vertical directions based on the motion vector of said input compressed picture information.

13. The picture information conversion apparatus according to claim 12 wherein said motion compensation means executes interpolation in the horizontal direction to ½ pixel precision, using a double-interpolation digital filter, said motion compensation means executing interpolation to ¼ pixel precision by linear interpolation.

14. The picture information conversion apparatus according to claim 12 wherein said motion compensation means executes interpolation in the horizontal direction on said macroblock in a frame mode to ½ pixel precision, using a double interpolation digital filter, said motion compensation means also executing intra-field interpolation to ¼ pixel precision by linear interpolation.

15. The picture information conversion apparatus according to claim 12 wherein said motion compensation means executes interpolation in the vertical direction on said macroblock in a frame mode to ½ pixel precision, using a double interpolation digital filter, said motion compensation means also executing intra-field interpolation to ¼ pixel precision by linear interpolation.

16. The picture information conversion apparatus according to claim 12 wherein said digital filter is a half-band filter.

17. The picture information conversion apparatus according to claim 16 wherein said digital filter previously calculates coefficients equivalent to a series of interpolation operations to apply said coefficients directly to pixel values depending on values of the motion vector of a macroblock of said input compressed picture information.

18. The picture information conversion apparatus according to claim 12 wherein said motion compensation means virtually creates, for pixels lying outside a picture frame of a picture forming said input compressed picture information required for effecting double interpolation filtering, pixels as necessary outside said picture frame of said picture, by way of a filtering processing operation.

19. The picture information conversion apparatus according to claim 18 wherein said motion compensation means mirrors preexisting pixels at a pre-set location of an array of said pixels, elongates said array of the pre-existing pixels or uses pre-set values to create necessary pixels outside said picture frame.

20. The picture information conversion apparatus according to claim 1 wherein said scanning conversion means selects one of the first and second fields of an interlaced picture decoded by said decoding means to convert an interlaced picture having ½ resolution for both the horizontal and vertical directions with respect to said input compressed picture information to a progressively-scanned picture having a resolution of ½ in the horizontal direction and a resolution of ¼ in the vertical direction with respect to said input compressed picture information.

21. The picture information conversion apparatus according to claim 20 wherein said scanning conversion means adjusts the number of pixels in the vertical direction so as to cope with macroblock-accommodating processing in said encoding means.

22. The picture information conversion apparatus according to claim 1 wherein said decimating means performs ½ downsampling on a progressively-scanned picture of the input compressed picture information from said scanning conversion means, having a resolution of ½ in the horizontal direction and a resolution of ¼ in the vertical direction, to output a progressively-scanned picture having a resolution of ¼ for both the horizontal and vertical directions of said input compressed picture information.

23. The picture information conversion apparatus according to claim 22 wherein said decimating means performs downsampling using a low-pass filter having several taps.

24. The picture information conversion apparatus according to claim 22 wherein said decimating means adjusts the number of pixels in the horizontal direction so as to enable said encoding means to perform macroblock-based processing.

25. The picture information conversion apparatus according to claim 1 wherein said compressed picture information is made up of an intra-coded picture, obtained on intra-frame coding, an inter-frame forward predictive-coded picture, obtained on predictive-coding by referencing another picture in the forward direction, an inter-frame bi-directionally predictive-coded picture, obtained on predictive-coding by referencing other pictures in the forward and backward directions, and a splite picture, said encoding means encoding a picture based on said intra-coded picture and said forward predictive-coded picture.

26. The picture information conversion apparatus according to claim 1 wherein said compressed picture information has been motion-compensated by a motion vector, wherein there is provided motion vector synthesis means for synthesizing the motion-compensating vector, the motion vector associated with a picture output from said decimating means being synthesized based on the motion vector of said input compressed picture information, said encoding means performing the encoding based on said motion vector.

27. The picture information conversion apparatus according to claim 26 wherein there is provided motion vector detection means for detecting the motion vector based on a motion vector synthesized by said motion vector synthesizing means.

28. A picture information conversion method for converting the resolution of the compressed picture information obtained on discrete cosine converting a picture in terms of a macroblock made up of eight coefficients for both the horizontal and vertical directions, as a unit, said method comprising:
a decoding step for decoding an interlaced picture using only four coefficients for both the horizontal and vertical directions of the macroblock making up the input compressed picture information obtained on encoding the interlaced picture;
a scanning conversion step for selecting a first field or a second field of the interlaced picture decoded by said decoding step for generating a progressive-scanned picture;
a decimating step for decimating the picture generated by said scanning conversion step in the horizontal direction; and
an encoding step for encoding a picture decimated by said decimating step to the output picture information lower in resolution than said input picture.

29. The picture information conversion method according to claim 28 wherein said input compressed picture information is by the MPEG2 standard and wherein said output compressed picture information is by the MPEG2 4 standard.

30. The picture information conversion method according to claim 28 wherein said decimating step performs ½ downsampling in the horizontal direction of said picture and wherein said output compressed picture information has the resolution of ¼ for both the horizontal and vertical directions with respect to said input compressed picture information.

31. The picture information conversion method according to claim 28 wherein said input compressed picture information is made up of an intra-coded picture, encoded in a frame, a forward predictive-coded picture, obtained on inter-frame predictive coding by referencing another picture in the forward direction, and an inter-frame bi-directionally predictive-coded picture, obtained on inter-frame predictive coding by referencing other pictures in both the forward and backward directions, there being provided discriminating step for deciphering the type of the encoded picture forming the input compressed picture information for allowing passage therethrough of the intra-coded picture and the forward predictive-coded picture but discarding the bi-directionally predictive-coded picture, said decoding step being fed with the compressed picture information through said discriminating step.

32. The picture information conversion method according to claim 28 wherein said decoding step decodes only intra-coded and forward predictive-coded pictures.
